(19) United States
(12) Patent Application Publication
(10) Pub. No.: US 2012/0294500 A1
(43) Pub. Date: Nov. 22, 2012

(54) OPHTHALMOLOGIC IMAGING APPARATUS

(75) Inventors: Norihiko Utsunomiya, Machida-shi (JP); Mitsuro Sugita, Wien (AT)

(73) Assignee: CANON KABUSHIKI KAISHA, Tokyo (JP)

(21) Appl. No.: 13/575,006

(22) PCT Filed: Jan. 25, 2011
(86) PCT No.: PCT/JP2011/000387

§ 371 Date: Jul. 24, 2012

(30) Foreign Application Priority Data
Jan. 29, 2010 (JP) 2010-018500

(51) Int. Cl. G06K 9/00

(52) U.S. Cl. 382/128

(57) ABSTRACT

Provided is an ophthalmologic imaging apparatus suppressing the effect of a motion artifact caused by a movement of an eye to be inspected, comprising: a scanning unit for scanning, with first and second measuring beams, at least a part of an overlap area of scan areas thereof in an inspected eye, at different times, respectively; an image acquiring unit for acquiring first and second images of the inspected eye based on first and second return beams resulting from the first and second measuring beams being applied via the scanning unit and reflected by the inspected eye; an identification unit for identifying an image including a motion artifact from each of the first and second images; and an image forming unit for forming an image of the inspected eye based on the first and second images other than the images identified by the identification unit.

### TECHNICAL FIELD

The present invention relates to an ophthalmologic imaging apparatus that acquires an image of an eye to be inspected.

### BACKGROUND ART

Examples of ophthalmologic imaging apparatuses mainly include a scanning laser ophthalmoscope (SLO) and an optical coherence tomography (OCT) each of which acquires an image of an eye to be inspected using a scanning unit that performs scanning with a measuring beam. An image acquired using such apparatuses may have a deformation (or a displacement) called “motion artifact” caused by, e.g., small involuntary eye movements of the eye to be inspected.

PTL 1 discloses a technique that corrects a motion artifact generated in an acquired image. In this technique, images, each resulting from integration in the depth direction of a three-dimensional tomographic image acquired by unit of an OCT, are aligned using a two-dimensional image of a surface of a fundus, thereby correcting a motion artifact generated in the tomographic images.

Here, although there are several small involuntary eye movement types, in particular, a brief and large-magnitude eye movement called “microsaccade (or flick)” among these has a large effect as a motion artifact generated in an obtained image. From a perspective of diagnostic accuracy enhancement, it is desirable to reduce the effect of a microsaccade to enhance the quality of an image of an eye to be inspected.

### CITATION LIST

### Patent Literature

PTL 1: Japanese Patent Application Laid-Open No. 2007-130403

### SUMMARY OF INVENTION

The present invention which is to improve the quality of image of an eye to be inspected, provides an ophthalmologic imaging apparatus comprising:
a scanning unit for scanning, with first and second measuring beams from a light source, at least a part of an overlap area of scan areas for the first and second measuring beams in an eye to be inspected, at different times, respectively;
an image acquiring unit for acquiring first and second images of the eye to be inspected based on first and second return beams from the eye to be inspected, the first and second return beam resulting from the first and second measuring beams being applied via the scanning unit to the eye to be inspected;
an identification unit for identifying an image including a motion artifact from each of the first and second images; and
an image forming unit for forming an image of the eye to be inspected based on the first and second images other than the images identified by the identification unit.

An ophthalmologic imaging apparatus according to the present invention enables identifying an image including a motion artifact from each of first and second images of an eye to be inspected acquired by scanning a overlap scan area with first and second measuring beams at different times. Then, based on the first and second images other than the identified images, an image of the eye to be inspected with the effect of a microsaccade reduced can be formed. Consequently, the quality of the image of the eye to be inspected is enhanced, which can lead to diagnostic accuracy enhancement.

Further features of the present invention will become apparent from the following description of exemplary embodiments with reference to the attached drawings.

### BRIEF DESCRIPTION OF DRAWINGS

FIG. 1 is a diagram illustrating an example configuration of an optical system of an optical tomographic imaging apparatus according to an example of the present invention.

FIG. 2 is a block diagram illustrating an example configuration of a control unit in an optical tomographic imaging apparatus according to an example of the present invention.

FIG. 3A is a diagram illustrating an image acquisition range in a fundus for fundus scanning according to an example of the present invention.

FIG. 3B is a diagram illustrating an image acquisition range in a fundus for fundus scanning according to an example of the present invention.

FIG. 3C is a diagram illustrating an image acquisition range in a fundus for fundus scanning according to an example of the present invention.

FIG. 3D is a diagram illustrating an image acquisition range in a fundus for fundus scanning according to an example of the present invention.

FIG. 4A is a diagram illustrating an image alignment according to an example of the present invention.

FIG. 4B is a diagram illustrating an image alignment according to an example of the present invention.

FIG. 4C is a diagram illustrating an image alignment according to an example of the present invention.

FIG. 4D is a diagram illustrating an image alignment according to an example of the present invention.

FIG. 4E is a diagram illustrating an image alignment according to an example of the present invention.

FIG. 4F is a diagram illustrating an image alignment according to an example of the present invention.

FIG. 4G is a diagram illustrating an image alignment according to an example of the present invention.

FIG. 4H is a diagram illustrating an image alignment according to an example of the present invention.

FIG. 4I is a diagram illustrating an image alignment according to an example of the present invention.

### DESCRIPTION OF EMBODIMENTS

Next, an ophthalmologic imaging apparatus (imaging apparatus using an OCT and/or an SLO) according to an embodiment of the present invention will be described.

First, an OCT apparatus according to the present embodiment splits a low-coherence light beam emitted from a light source into a measuring beam and a reference beam. Then, an image is formed using an interfering signal resulting from multiplexing a return beam resulting from the measuring beam being reflected by the fundus of an eye to be inspected, which is an inspection object, and a reference beam that has passed through a reference light path, thereby acquiring a tomographic image of the fundus of the eye to be inspected.

One tomographic image of the fundus of an eye to be inspected is what is called a “B-scan image”.

A B-scan image is a tomographic image of a retina, which can be acquired as a result of scanning an eye to be inspected in a direction perpendicular to the eye axis (in general, a horizontal or vertical direction when a person takes an upright posture) with a measuring beam.

A scanning direction of a scanner in a fundus during a B-scan, which is orthogonal to the eye axis of an eye to be inspected, is here referred to as a “main scanning direction.”

In the present embodiment, a three-dimensional image of a retina is acquired by acquiring a B-scan image for a plurality of positions.

Here, a plurality of positions refers to positions in a scanning direction orthogonal to a main scanning direction.

Also, the scanning direction orthogonal to the main scanning direction is referred to as “auxiliary scanning direction”.

In order to acquire such B-scan images, a plurality of measuring beams is made to enter an eye to be inspected, while a plurality of reference beams, which is the same in number as the plurality of measuring beams, is used as well. Using a plurality of interfering light beams resulting from multiplexing return beams of the measuring beams, and the reference beams, respectively, a plurality of B-scan images is generated by unit of an image creation or forming unit.

A scanning unit that performs scanning in two directions in order to scan a fundus in the main scanning direction and the auxiliary scanning direction of the fundus with the plurality of beams includes a set of scanning units. Furthermore, in the present embodiment, the plurality of beams are arranged so that the beams are applied to positions in the fundus, which are different in the auxiliary scanning direction, and the scanning ranges in the auxiliary scanning direction of the respective beams have respective overlap areas.

Using the plurality of beams (also referred to “first and second measuring beams”) as described above, scanning is performed so as to acquire images (also referred to as “first and second images”) of a same area of the fundus of an eye to be inspected at different times. In other words, at least a part of an overlap area of the scanning areas for the first and second measuring beams in the eye to be inspected is scanned. In other words, when acquiring the image including the motion artifact in the first image, the overlap area in the eye to be inspected is scanned by the first measuring beam, and the overlap area is scanned by the second measuring beam at a time different from the time of the scanning with the first measuring beam.

When acquiring B-scan images for different positions by unit of respective beams, a plurality of B-scan images is acquired in the auxiliary scanning direction to form a three-dimensional data set. Three-dimensional data sets acquired by the respective beams have respective overlap areas.

Based on the three-dimensional data sets acquired as described above (from the first and second images), an area in which a motion artifact has occurred due to an eye movement during the image acquisition is identified. An area in which a motion artifact has occurred is identified for all of the respective three-dimensional data sets acquired by the plurality of beams.

Then, using images of the areas other than the area in which a motion artifact has occurred (based on the first and second images other than the identified image), an image is formed by combining these images by unit of a unit for forming an image of a fundus. Here, an image acquired by scanning the overlap area with the second measuring beam at the different time can be extracted from the second image other than the identified image. Consequently, an image of the eye to be inspected can be formed based on the extracted image and the first image other than the identified image. In the OCT apparatus according to the present invention, as described above, an image of an eye to be inspected is formed using images of areas other than an area in which a motion artifact has occurred.

Consequently, a wide-view-angle, three-dimensional data sets can be acquired, enabling provision of a three-dimensional tomographic image with a reduced effect of a motion artifact caused by an eye movement.

Here, acquiring an image of a first area of an eye to be inspected at a first time and acquiring an image of a second area of the eye to be inspected at a second time using a first measuring beam is considered. Also, acquiring an image of a second area of an eye to be inspected at a first time and acquiring an image of a third area of the eye to be inspected at a second time using a second measuring beam is considered. Supposing that a motion artifact occurred at the second time, the image of the second area acquired using the first measuring beam cannot be used. Therefore, the image of the second area acquired at the first time using the second measuring beam is used to form an image of the eye to be inspected.

### Example

An example configuration of an optical tomographic imaging apparatus according to an example to which the present invention has been applied will be described below.

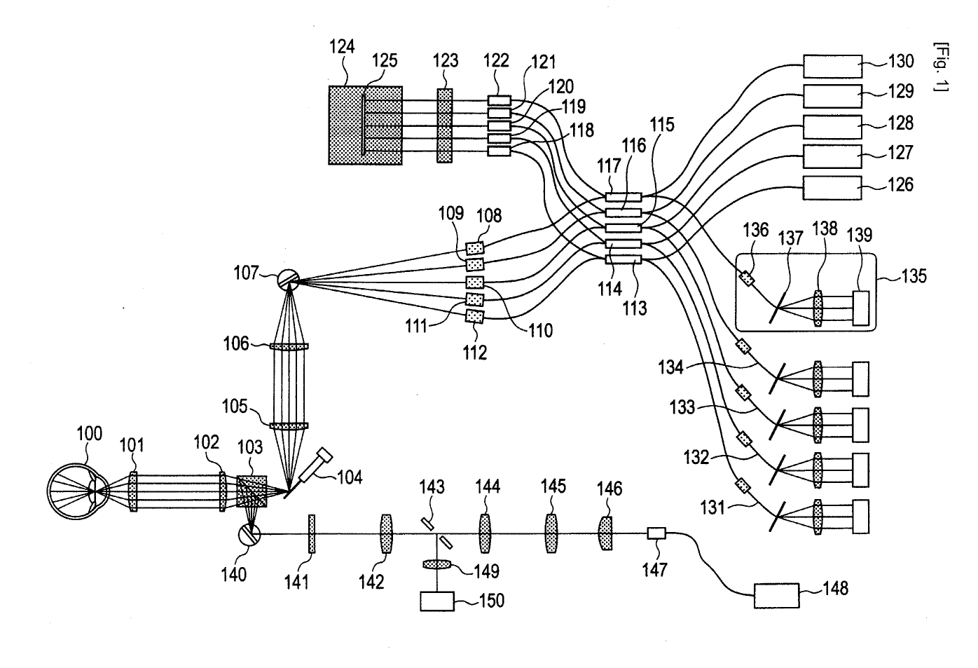

First, a configuration of an optical system of the optical tomographic imaging apparatus according to the present example will be described with reference to FIG. 1. The optical tomographic imaging apparatus according to the present example includes a multibeam configuration in which a plurality of beams is made to enter an eye to be inspected.

In the present example, as described in FIG. 1, an optical tomographic imaging apparatus using a multibeam including five beams is provided as an example.

Although an example multibeam configuration including five beams is provided here, the multibeam configuration according to the present invention is not limited to such configuration, and the multibeam may include two or more beams.

In the present example, a multibeam including five beams is used as described above, and thus, five low-coherence light sources 126 to 130 are used.

Although five independent low-coherence light sources are used here, it should be understood that a plurality of beams resulting from splitting a beam from one low-coherence light source may also be used.

Furthermore, it should be understood that beams from two or more light sources may be first combined and then the combined beam may be split into five beams.

For the low-coherence light sources, SLD (super luminescent diode) light sources or ASE (amplified spontaneous emission) light sources can be used.

SS (swept source) light sources may also be used; however, in that case, it should be understood that it is necessary to employ the structure of an SS-OCT for the entire con-figuration as opposed to the configuration illustrated in FIG. 1.

For wavelengths favorable for a beam, which is low-coherence light, wavelengths around 850 and 1050 nm can be used for fundus image acquisition.

In the present example, for each light source, a SLD light source with a center wavelength of 840 nm and a wavelength half width of 45 nm is used.

As illustrated in FIG. 1, five low-coherence light beams provided from the low-coherence light sources 126 to 130 enter five fiber couplers 113 to 117 via fibers and each of the five low-coherence light beams is split into a measuring beam and a reference beam.

Although a fiber-used interferometer configuration is described here, a beam splitter-used spatial optical system configuration may be employed.

The measuring beams are further output from fiber collimators 108 to 112 in the form of collimated beams via fibers.

Furthermore, the five measuring beams are adjusted so that the centers of their respective optical axes are incident on and reflected by the rotational axis of a mirror surface of an OCT scanner (Y) 107.

Also, the respective angles of the five measuring beams incident on the OCT scanner (Y) 107 are arbitrarily determined according to the relationship of irradiated positions in the fundus between the respective beams, which will be described later.

The measuring beams reflected by the OCT scanner (Y) 107 pass through relay lenses 106 and 105 and further pass through an OCT scanner (X) 104.

Then, the measuring beams penetrate a dichroic beam splitter 103, pass through a scan lens 102 and an ocular lens 101 and then enter an eye to be inspected 100.

Here, for the OCT scanners (X) 104 and (Y) 107, galvano scanners are used.

The five measuring beams that have entered the eye 100 are reflected by the retina and return to the respective corresponding fiber couplers 113 to 117 through the same optical paths.

The reference beams are guided from the fiber couplers 113 to 117 to fiber collimators 118 to 122 and output in the form of five collimated beams.

The output reference beams pass though a dispersion correction glass 123 and are reflected by a reference mirror 125 on an optical path length changing stage 124.

A size corresponding to the optical paths of the five beams is secured for the dispersion compensation glass 123 and the reference mirror 125.

The reference beams reflected by the reference mirror 125 return to the fiber couplers 113 to 117 through the same optical paths.

The measuring beams and the reference beams that have returned to the fiber couplers 113 to 117 are multiplexed by the fiber couplers 113 to 117 and guided to spectroscopes 131 to 135. Also, the multiplexed beams are here referred to as “interfering beams”.

In the present example, the five spectroscopes have a same configuration, and thus, the configuration will be described taking the spectroscope 135 as an example.

The spectroscope 135 includes a fiber collimator 136, a grating 137, a lens 138 and a line sensor camera 139.

An interfering beam is measured by a spectroscope in the form of intensity information for respective wavelengths. In other words, an OCT imaging unit in the present example employs a spectral domain method.

Next, an optical configuration of an SLO imaging unit will be described also with reference to FIG. 1.

For a laser light source 148, a semiconductor laser or an SLD light source can be used. For a wavelength to be employed for the light source, there is no limitation as long as the wavelength is one that can be separated by the dichroic beam splitter 103, which separates the wavelength from the wavelengths for the low-coherence light sources 126 to 130. For an image quality of a fundus observation image, a near-infrared wavelength range of 700 to 1000 nm may be employed.

In the present example, a semiconductor laser with a wavelength of 760 nm is employed.

A laser emitted from the laser light source 148 is output from a fiber collimator 147 in the form of a collimated beam via a fiber and enters a cylinder lens 146. Although a cylinder lens is employed in the present example, any optical element that can generate a line beam can be employed with no specific limitations, and thus, a Powell lens or a line beam shaper using a diffraction optical element can be employed.

The beam (SLO beam) that has been expanded by the cylinder lens 146 is made to pass through a center of a ring mirror 143 by relay lenses 145 and 144, and guided to a SLO scanner (Y) 140 via relay lenses 141 and 142.

For the SLO scanner (Y) 140, a galvano scanner is employed. The beam is further reflected by the dichroic beam splitter 103, and enters the eye to be inspected 100 through the scan lens 102 and the ocular lens 101.

The dichroic beam splitter 103 is configured so as to transmit OCT beams (measuring beams in the OCT imaging unit) and reflect SLO beams.

In the present example, one having a film configuration, which transmits a wavelength of no less than 800 nm and reflects a wavelength of less than 770 nm is employed.

The SLO beam that has entered the eye to be inspected 100 is applied to the fundus of the eye to be inspected in the form of a line-shaped beam (line beam).

This line-shaped beam is reflected or scattered by the fundus of the eye to be inspected and returns to the ring mirror 143 though the same optical path.

The position of the ring mirror 143 is conjugate to the position of the pupil of the eye to be inspected, and thus, light that has passed through the region around the pupil, in light resulting from backscattering of the line beam applied to the fundus, is reflected by the ring mirror 143 and forms an image on a line sensor camera 150 via a lens 149.

Although in the present example, an SLO imaging unit having a line scan SLO con-figuration using a line beam has been described, it should be understood that the SLO imaging unit may have a flying-spot SLO configuration.

Next, an example configuration of a control unit and a control method of the optical tomographic imaging apparatus according to the present example will be described with reference to the block diagram in FIG. 2.

In FIG. 2, a central processing unit (CPU) 201 is connected to a display apparatus 202, a fixed disk apparatus 203, a main memory apparatus 204 and a user interface 205.

The CPU 201 is connected also to a focus motor driver 206 and an OCT stage controller 207.

The CPU 201 is further connected to a scanner drive unit 208 that controls a scanner, and controls an OCT scanner driver (X) 209, an OCT scanner driver (Y) 210 and an SLO scanner driver (Y) 211 via the scanner drive unit 208.

Five OCT line sensor cameras 212 to 216, which correspond to the five beams, are connected to the CPU 201 as sensors in the spectroscopes in the OCT imaging unit, and an SLO line sensor camera 217 is also connected to the CPU 201 as a sensor in the SLO imaging unit.

Next, an operation during image acquisition will be described.

During image acquisition, the central processing unit 201 provides an instruction to the scanner drive unit 208 to make the OCT scanner driver (X) 209 and the OCT scanner driver (Y) 210 perform driving for raster scanning with the X-axis direction as the main scanning (high-speed scanning direction).

In synchronization with the driving, data are acquired by the OCT line sensor cameras 212 to 216. The data acquired by the OCT line sensor cameras 212 to 216 are transferred to the CPU 201, and the CPU 201 generates tomographic images based on the transferred data.

The amplitudes of the respective scanners at this stage are arbitrarily set according to the acquisition intervals for the respective beams on the fundus, which will be described later, and the overall scanning range.

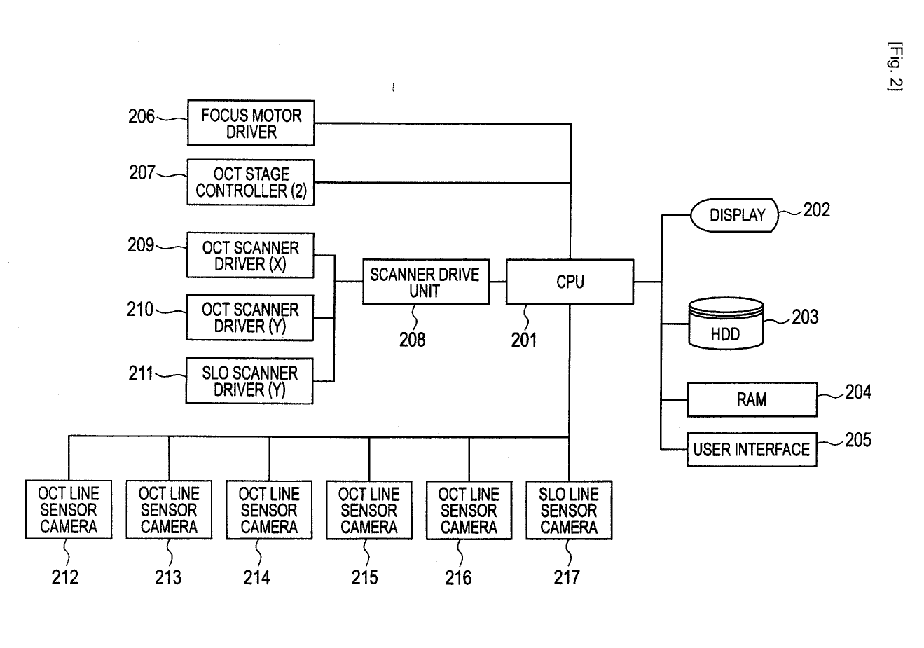

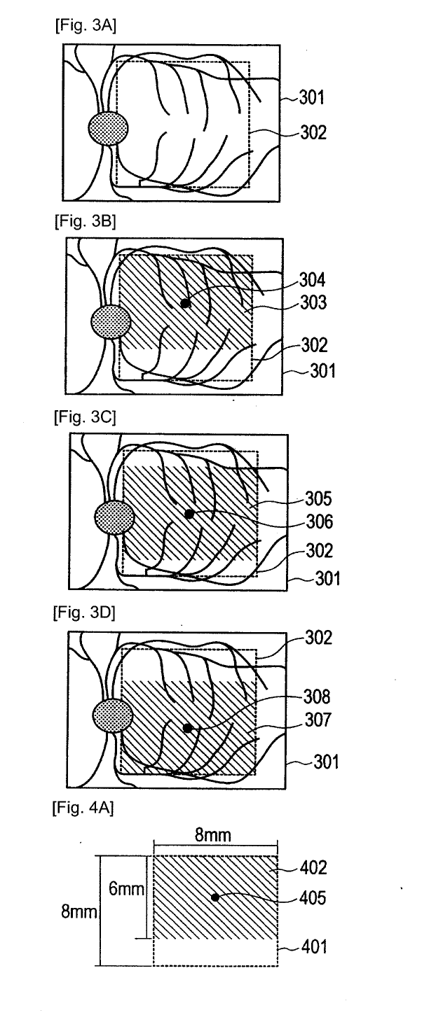

Next, an image acquisition range in the fundus will be described with reference to FIGS. 3A to 3D. Here, for ease of description, the description will be provided in terms of a three-beam configuration.

FIG. 3A is a conceptual diagram of an imaging range for an optical tomographic imaging apparatus according to the present example.

The illustration includes a planar fundus image 301 provided by the SLO and a three-dimensional imaging range 302 provided by the OCT, which is a portion indicated by dashed lines in the planar fundus image 301.

The three-dimensional imaging range 302 provided by the OCT is here an area of 8×8 mm in the fundus.

FIG. 3B illustrates an imaging range for a beam 1, which is one of the three beams. The hatched pattern portion in the Figure is a three-dimensional imaging range for the beam 1.

FIG. 3C illustrates an imaging range for a beam 2. The hatched pattern portion in the Figure is a three-dimensional imaging range for the beam 2.

FIG. 3D illustrates an imaging range for a beam 3. The hatched pattern portion in the Figure is a three-dimensional imaging range for the beam 3.

A three-dimensional imaging range for one beam is a range of 8×6 mm, and the arrangement of the respective scanning ranges of the beams 1, 2 and 3 is set so that respective scanning centers 304, 306 and 308 are arranged away from one another by 1 mm in the auxiliary scanning direction.

The beam arrangement here is made so that there is a plurality of scan lines within the distance between the scanning centers in the auxiliary scanning direction (inter-beam distance: 1 mm here).

Here, the scan line pitch in the auxiliary scanning direction is 25 micrometer, providing an arrangement of 40 scan lines within 1 mm. For the scanning speed in the auxiliary scanning direction, here, an image is acquired at a speed of 25 msec per main scanning.

Accordingly, time required for travelling for the inter-beam distance at the auxiliary scanning speed is one second. The time of travel for the inter-beam distance at the auxiliary scanning speed desirably includes the duration of a microsaccade and the time of an eye blink: the duration of a microsaccade is a maximum of approximately 30 msec and the duration of an eyeblink is approximately 100 msec.

In other words, it is desirable that the distance between the beams in the auxiliary scanning direction be arranged so as to require no less than 30 msec to travel at the scanning speed when scanning is performed with the plurality of beams in the auxiliary scanning direction. It is more desirable that the distance between the beams be arranged so as to require no less than 100 msec to travel at the auxiliary scanning speed.

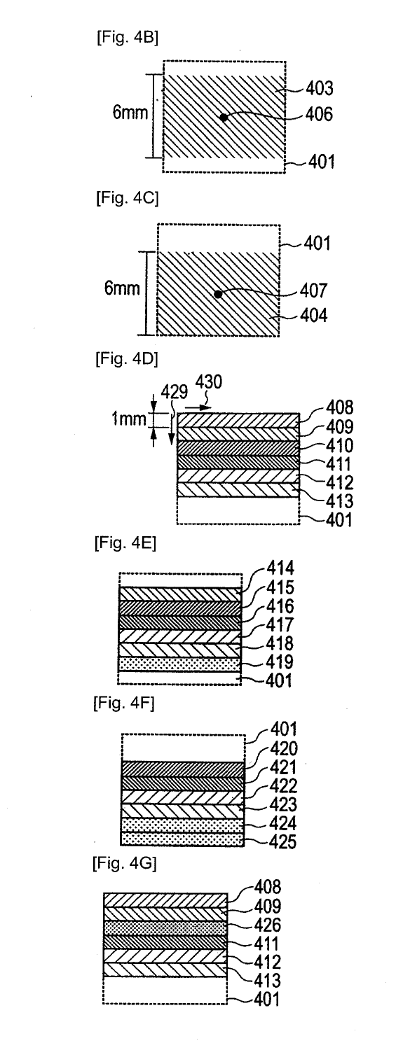

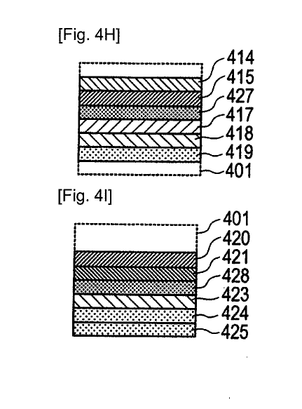

Next, processing for correcting an acquired image, which is processing for detecting a motion artifact, will be described with reference to FIGS. 4A to 41.

FIGS. 4A, 4B and 4C are diagrams corresponding to FIGS. 3B, 3C and 3D, respectively.

These Figures illustrate scan ranges and scanning center positions of the beams 1, 2 and 3, respectively.

A three-dimensional imaging range 402 for the beam 1 is positioned in an overall three-dimensional imaging range 401.

FIG. 4D is a conceptual diagram illustrating the three-dimensional imaging range 402 for the beam 1 divided into a plurality of areas, i.e., image areas 1 to 6 (408 to 413).

In this area division, the division interval is 1 mm in the auxiliary scanning direction. It is desirable to set this division interval to be equal to or smaller than the distance between the plurality of beams in the auxiliary scanning direction.

Here, the illustration indicates a main scanning direction 430 and an auxiliary scanning direction 429. Whether or not there is a motion artifact is determined for each image area.

For a start, all the scan images are aligned in the depth direction.

First, FFT processing is performed for an image area in the auxiliary scanning direction 429. Then, data subjected to FFT signal processing are subjected to addition or averaging processing in the depth direction, and then, a signal resulting from the FFT signal processing in the main scanning direction 430 is subjected to addition or averaging processing.

If the intensity of high-frequency components of the signal resulting from the addition or averaging is no less than a certain threshold value, a motion artifact caused by an eye movement is regarded as occurring (identified). (An identification unit (not illustrated) that performs this identification is provided inside or outside the CPU 201.)

In other words, processing for determining whether or not there is a non-continuous surface in the auxiliary scanning direction of a three-dimensional structure is performed.

When a high-speed eye movement such as a microsaccade has occurred during three-dimensional data acquisition, continuity of data in the auxiliary scanning direction is lost, increasing the intensity of the high-frequency components, which can be used for detection of an eye movement.

The above-described processing is repeatedly performed for the image areas 1 to 6 (408 to 413).

FIGS. 4E and 4F are conceptual diagrams for beams 2 and 3, respectively.

Among these image areas, image areas 426, 427 and 428 including a motion artifact can be figured out as illustrated in FIGS. 4G, 4H and 4I.

In other words, the Figures indicate that the image areas 3 for the respective beams include a motion artifact. This is because at the point of time of occurrence of an eye movement, an image motion artifact occurs in all the beams.

Here, an image area in which a motion artifact has occurred is figured out using three-dimensional data for the respective beams in the OCT only; however, the identification method is not limited to this.

For example, an area in which a motion artifact has occurred may be identified by using three-dimensional data 408, 414 and 420 acquired for different positions at a same scanning timing among the beams and performing frequency analysis of these images.

More specifically, a motion artifact may also be detected by comparing these frequency component analysis results with frequency component analysis results for another same scan timing.

For another method, correlation analysis may be performed on OCT integrated images (planar fundus images acquired by integrating the pixel values in the depth direction) obtained from three-dimensional data of the respective beams for a same position to identify an image of a beam having a low correlation as having a motion artifact.

Also, a motion artifact in an SLO image acquired by the above-described SLO imaging unit (planar image acquisition unit), which is provided separately from the OCT imaging unit and OCT integrated images (planar fundus images obtained by integrating the pixel values in the depth direction) generated from three-dimensional data for the respective image areas may be analyzed.

Determination of a motion artifact may be made based on such analysis.

Next, an image combination method for forming wide-view-angle three-dimensional data based on the images acquired as described above, motion artifact occurrence areas of which have been figured out, will be described.

Since the image areas 426, 427 and 428 in FIGS. 4G, 4H and 4I are motion artifact occurrence areas, a motion artifact has occurred at a position in the planar (main scanning and auxiliary scanning) direction of three-dimensional data at a certain point of time during the scanning.

Data for the image areas 426, 427 and 428 in which a motion artifact has occurred are not used, and the other parts of the data are aligned to form three-dimensional data.

Accordingly, first, alignment in the planar direction of the data before occurrence of the motion artifact is performed.

Here, the alignment is performed based on a position of images acquired by the beams for a same coordinate.

For example, an OCT integrated image for the image area 409, which is the image area 2 for the beam 1, and an OCT integrated image for the image area 414, which is the image area 1 for the beam 2, are aligned.

Furthermore, an OCT integrated image for the image area 415, which is the image area 2 for the beam 2, and an OCT integrated image for the image area 420, which is the image area 1 for the beam 3, are aligned.

The alignment here can be performed by pattern matching between the OCT integrated images.

Similarly, alignment in the planar direction of the data after occurrence of the motion artifact is performed. The alignment is similar to the alignment of the data before occurrence of the motion artifact: the alignment in the planar direction can be performed by aligning data for image areas 412 and 417 and aligning data for image areas 418 and 423. Subsequently, alignments of the data before and after occurrence of the motion artifact are performed.

Here, data for image areas 411 and 421 acquired for a same scan position are aligned.

With the above-described alignment, the alignment in the planar direction of the overall scan area is completed.

With the process as described above, alignment of all the three-dimensional data is completed. Data for an overlap portion may be subjected to averaging processing, or a part of the data may be used as a representative. Use of averaging processing enables provision of an image with a high S/N ratio.

Although the above-described embodiment and example have been described in terms of an optical tomographic imaging apparatus, the present invention is not limited to this.

The present invention can also be applied to an SLO (scanning laser ophthalmoscope) apparatus using a plurality of measuring beams, which scans a retina with the measuring beams to obtain the reflection intensity of each measuring beams or the intensity of fluorescence excited by each measuring beam. Also, for the optical imaging apparatus control method in the example described above, it is possible that a program for making a computer execute such control method is produced and the program is stored in a recording medium to make a computer read the program.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-018500, filed Jan. 29, 2010, which is hereby incorporated by reference herein in its entirety.

1. An ophthalmologic imaging apparatus comprising:
a scanning unit for scanning, with first and second measuring beams from a light source, at least a part of an overlap area of scan areas for the first and second measuring beams in an eye to be inspected, at different times, respectively;
an image acquiring unit for acquiring first and second images of the eye to be inspected based on first and second return beams from the eye to be inspected, the first and second return beam resulting from the first and second measuring beams being applied via the scanning unit to the eye to be inspected;
an identification unit for identifying an image including a motion artifact from each of the first and second images; and
an image forming unit for forming an image of the eye to be inspected based on the first and second images other than the images identified by the identification unit.

2. The ophthalmologic imaging apparatus according to claim 1, wherein when acquiring the image including the motion artifact in the first image, the scanning unit scans the overlap area in the eye to be inspected with the first measuring beam, and scans the overlap area with the second measuring beam at a time different from the time of the scanning with the first measuring beam.

3. The ophthalmologic imaging apparatus according to claim 2, comprising extraction unit for extracting an image acquired by scanning the overlap area with the second measuring beam at the different time, from the second image other than the image identified by the identification unit,
wherein the image forming unit forms an image of the eye to be inspected based on the image extracted by the extraction unit and the first image other than the image identified by the identification unit.

4. The ophthalmologic imaging apparatus according to claim 3, wherein the image forming unit performs alignment of an area of the first image other than the image identified by the identification unit, with the image extracted by the extraction unit.

5. The ophthalmologic imaging apparatus according to claim 3, wherein the image forming unit corrects an area of the first image, the area corresponding to the image identified by the identification unit in the first image, using the image extracted by the extraction unit.

6. The ophthalmologic imaging apparatus according to claim 3, wherein the image forming unit performs processing for averaging the first and second images identified by the identification unit.

7. The ophthalmologic imaging apparatus according to claim 1, wherein the identification unit identifies the third image by performing frequency analysis of the first image.

8. The ophthalmologic imaging apparatus according to claim 1, wherein the scan areas for the first and second measuring beams partially overlap in an auxiliary scanning direction of the scanning unit.

9. The ophthalmologic imaging apparatus according to claim 8, comprising distance providing unit for providing a distance in the auxiliary scanning direction between positions irradiated with the first and second measuring beams in the eye to be inspected based on an auxiliary scanning speed of the scanning unit and a small involuntary eye movement of the eye to be inspected.

10. The ophthalmologic imaging apparatus according to claim 8, wherein the distance in the auxiliary scanning direction between positions irradiated by the first and second measuring beams in the eye to be inspected is a distance requiring no less than 30 msec to travel at the auxiliary scanning speed of the scanning unit.

11. The ophthalmologic imaging apparatus according to claim 8, wherein the distance in the auxiliary scanning direction between positions irradiated by the first and second measuring beams in the eye to be inspected is a distance requiring no less than 100 msec to travel at the auxiliary scanning speed of the scanning unit.

12. The ophthalmologic imaging apparatus according to claim 1, wherein the image acquiring unit acquires first and second tomographic images of the eye to be inspected, based on beams resulting from multiplexing the first and second return beams and reference beams corresponding to the first and second measuring beams, respectively.
